(19) United States
(12) Patent Application Publication
(10) Pub. No.: US 2012/0206063 A1
(43) Pub. Date: Aug. 16, 2012

(54) LED Current Regulator

(75) Inventor: Wei Wu, Cupertino, CA (US)

(73) Assignee: DIODES INCORPORATED, Plano, TX (US)

(21) Appl. No.: 13/363,687

(22) Filed: Feb. 1, 2012

Related U.S. Application Data
(60) Provisional application No. 61/442,172, filed on Feb. 11, 2011.

(51) Int. Cl. H05B 37/00

(52) U.S. Cl. 315/294

(57) ABSTRACT

A circuit includes a plurality of first current-regulator portions, and a second current-regulator portion. The circuit further includes a plurality of switches coupled to the second current-regulator portion. The plurality of switches is configured to sequentially and selectively couple and decouple the first current-regulator portions to the second current-regulator portion to sequentially form a plurality of current regulators. The current regulators are configured to regulate current flow through light emitting diodes (LEDs), which are respectively associated with the first current-regulator portions. The circuit provides for substantially equal luminosity generation by the LEDs via the relatively lowering of voltage and current mismatch between the formed current regulators.

### CROSS REFERENCE TO RELATED APPLICATIONS

This application claims the benefit of, and priority to, U.S. Provisional Patent Application No. 61/442,172, filed Feb. 11, 2011, titled “LED Current Regulator,” of Wu, and is incorporated by reference herein in its entirety.

### BACKGROUND

The present invention generally relates to current regulators, and more particularly relates to current regulators for diodes, such as light emitting diodes (LEDs).

Unless otherwise indicated herein, the approaches described in the background section are not prior art to the claims in this application and are not admitted to be prior art by inclusion in the background section.

LEDs are relatively efficient light sources that generate relatively high luminosity and with relatively low power consumption. Several LEDs are often included in a light source. For example, several LEDs are often included in light sources used in portable devices, such as mobile phones and personal digital assistants to light backlight buttons and backlight displays. Several LEDs are also often included in light sources used in monitors and displays for backlighting.

One goal for using a number of LEDs in a light source is to provide that each LED generates substantially the same luminosity. Another goal for using a number of LEDs in a light source is to provide that each LED generates substantially the same set of wavelengths. A “set” as referred to herein includes one or more elements. Providing that each LED in a light source generates substantially the same luminosity at substantially the same set of wavelengths is sometimes referred to a providing relatively “good” channel-to-channel matching performance. A light source typically includes a number of channels and each channel typically includes a single LED and may include the circuitry configured to control current flow through the LED.

Several LEDs operating as a light source may be configured to generate substantially the same luminosity and substantially the same set of wavelengths by providing that substantially the same amount of current is sourced to each LED or pull downed through each LED. Traditional light sources that include a number of LEDs include a current regulator for each LED in the light source. A number of current regulators in a circuit tend to take up a relatively large amount of die area on an integrated circuit (IC) and tend to have a relatively high quiescent current. Moreover, while a relatively well designed layout of current regulators may be provided for an IC, the current driven through the LEDs by the current regulators may vary causing luminosity differences of as much as 2%-3% and similar differences in the wavelengths.

FIG. 1 is a simplified schematic of a traditional light source 100 that includes a number of channels 101a, 101b . . . 101n. The channels include respective LEDs 105a, 105b . . . 105n and include respective current regulators 110a, 110b . . . 110n. The current regulators are generally indicated by the surrounding dashed lines in FIG. 1. Each current regulator is configured to control current ILED pulled down through an associated LED. Each current regulator includes an op-amp (the op-amps are labeled 115a, 115b . . . 115n), a first pull-down transistor (the first pull-down transistors are labeled 120a, 120b . . . 120n), and a second pull-down transistor (the second pull-down transistors are labeled 125a, 125b . . . 125n). Each current regulator is configured to mirror a current Io from a current source (the current sources are labeled 130a, 130b . . . 130n) through an associated LED. Each op-amp is configured to receive a voltage from one of the current sources and receive a voltage from an output node of one of the LEDs and is configured to control the gates of the first and second pull-down transistors, which are coupled to the op-amp, for current mirroring. Each op-amp is further configured to equalize the voltages at a drain of one of the first pull-down transistors (which is coupled between the output node of the LED and ground) and a drain of one of the second pull-down transistors (which is coupled between the current source and ground) to provide for relatively accurate mirroring of the current pulled Io and ILED from the current source and the LED.

Current and voltage mismatches within the channels and across the channels tend to cause the LEDs to have different luminosities and generate different wavelengths. For example, current mismatches across the current sources of different channels and DC voltage differences across the op-amps tend to cause the LEDs to have different luminosities and generate different wavelengths. Further, differences between the first pull-down transistors of the different channels and differences between the second pull-down transistors of the different channels also tend to cause the LEDs to have different luminosities and generate different wavelengths and tend to be a predominant source for current mismatch in the LEDs. Further, differences between first and second pull-down transistor in a single channel compared to first and second pull-down transistors in another channel also tend to be a relatively significant source of voltage and current mismatch and cause the LEDs to have different luminosities and generate different wavelengths.

There is a need for improved current regulator designs for LEDs operating as a light source to provide substantially uniform luminosity by each LED and to provide substantially uniform wavelength generation by each LED.

### SUMMARY

The present invention generally relates to current regulators, and more particularly relates to current regulators for diodes, such as light emitting diodes (LEDs).

According to one embodiment of the present invention, a circuit includes a plurality of first current-regulator portions, and a second current-regulator portion. The circuit further includes a plurality of switches coupled to the second current-regulator portion. The plurality of switches is configured to sequentially and selectively couple the first current-regulator portions to the second current-regulator portion to sequentially form current regulators. The current regulators are configured to regulate current flow through light emitting diodes (LEDs), which are respectively associated with the first current-regulator portions.

According to a specific embodiment, the circuit further includes a digital control block coupled to the plurality of switches, wherein the digital control block is configured to control the plurality of switches to sequentially and selectively couple the first current-regulator portions to the second current-regulator portion.

According to another specific embodiment, each of the first current-regulator portions includes a first pull-down transistor having a first terminal coupled to ground and a second terminal configured to be coupled to one of the LEDs to pull current through the LED.

According to another specific embodiment, the circuit further includes a current source coupled to a supply voltage. The second current-regulator portion includes: a second pull-down transistor having a first terminal coupled to the current source and a second terminal one of the switches, and an op-amp having a first input coupled to the first terminal, a second input coupled to one of the switches, and an output coupled to a gate of the second pull-down transistor.

According to another specific embodiment, a gate of each of the first pull-down transistors is larger than the gate of the second pull-down transistor.

According to another specific embodiment, each of the first pull-down transistors is configured to remain on during periods that the switches are open and closed.

According to another specific embodiment, each of the first current-regulator portions includes a second transistor disposed in series with the first pull-down transistor between an output node of one of the LEDs and ground.

According to another specific embodiment, the digital control block is coupled to a gate of each of the second transistors to turn the second transistors on and off to dim the LEDs.

According to another specific embodiment, each of the first current-regulator portions includes a first pull-up transistor having a first terminal coupled to a supply voltage and a second terminal is coupled to one of the LEDs to source current to the LED.

According to another specific embodiment, the circuit further includes a current source coupled to a supply voltage, wherein the second current-regulator portion includes: a second pull-up transistor having a first terminal coupled to the current source and a second terminal one of the switches, and an op-amp having a first input coupled to the first terminal, a second input coupled to one of the switches, and an output coupled to a gate of the second pull-up transistor.

According to another specific embodiment, a gate of each the first pull-up transistors is larger than a gate of the second pull-down transistor.

According to another specific embodiment, each of the first pull-up transistors is configured to remain on during periods that the switches are open and closed.

According to another specific embodiment, each of the first current-regulator portions includes a transistor disposed in series with the first pull-down transistor between an output node of one of the LEDs and ground.

According to another specific embodiment, the digital control block is coupled to a gate of each of the transistors to turn the transistors on and off to dim the LEDs.

According to another embodiment of the present invention, a circuit method for operating an LED light source includes sequentially coupling and decoupling each first current-regulator portion of a plurality of first current-regulator portions to a second current-regulator portion to sequentially form and un-form current regulators, and driving current through each LED of a plurality of LEDs via each of the formed current regulators.

According to a specific embodiment, the step of sequentially coupling and decoupling each first current-regulator portion includes sequentially opening and closing sets of switches to sequentially couple and decouple each of the first current-regulator portions to the second current-regulator portion.

According to another specific embodiment, the driving step includes mirroring a current from a current source through each of the LEDs via the formed current regulators.

According to another specific embodiment, the driving step includes pulling current down through output nodes of the LEDs via the formed current regulators.

According to another specific embodiment, the driving step includes pulling current down through each of the output nodes of each of the LEDs via the LED's first current regulator portions during a period that a current regulator is not formed for the LED.

According to another specific embodiment, the driving step includes sourcing current to input nodes of the LEDs via the formed current regulators.

According to another specific embodiment, the driving step includes sourcing to the input nodes of each of the LEDs via the LED's first current regulator portions during a period that a current regulator is not formed for the LED.

The following detailed description and accompanying drawings provide a better understanding of the nature and advantages of the present invention.

### BRIEF DESCRIPTION OF THE DRAWINGS

FIG. 1 is a simplified schematic of a traditional light source that includes a number of channels;

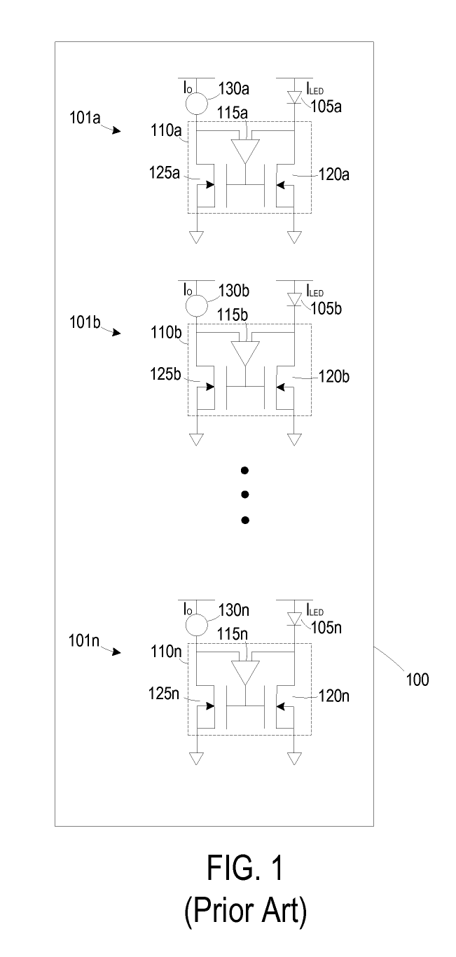

FIG. 2 is a simplified schematic of a light source according to an embodiment of the present invention;

FIG. 3 is a simplified schematic of a light source according to another embodiment of the present invention where LEDs of the light source are configured to be dimmed;

FIG. 4 is a simplified schematic of a light source according to another embodiment of the present invention;

FIG. 5 is a simplified schematic of a light source according to another embodiment of the present invention where LEDs of the light source are configured to be dimmed; and

FIG. 6 is a high-level flow diagram of a method of operating a light source according to one embodiment of the present invention.

### DETAILED DESCRIPTION

The present invention generally provides a current regulator, and more particularly provides current regulators for controlling the current driven through a number of diodes, such as a number of light emitting diodes (LEDs) operating as a light source.

In the following description, for purposes of explanation, numerous examples and specific details are set forth in order to provide a thorough understanding of specific embodiments of the present invention. It will be evident, however, to one skilled in the art that the present invention as defined by the claims may include some, or all, of the elements and features in the examples alone or in combination with other elements and features described below, and may further include modifications and equivalents of the elements and features described herein.

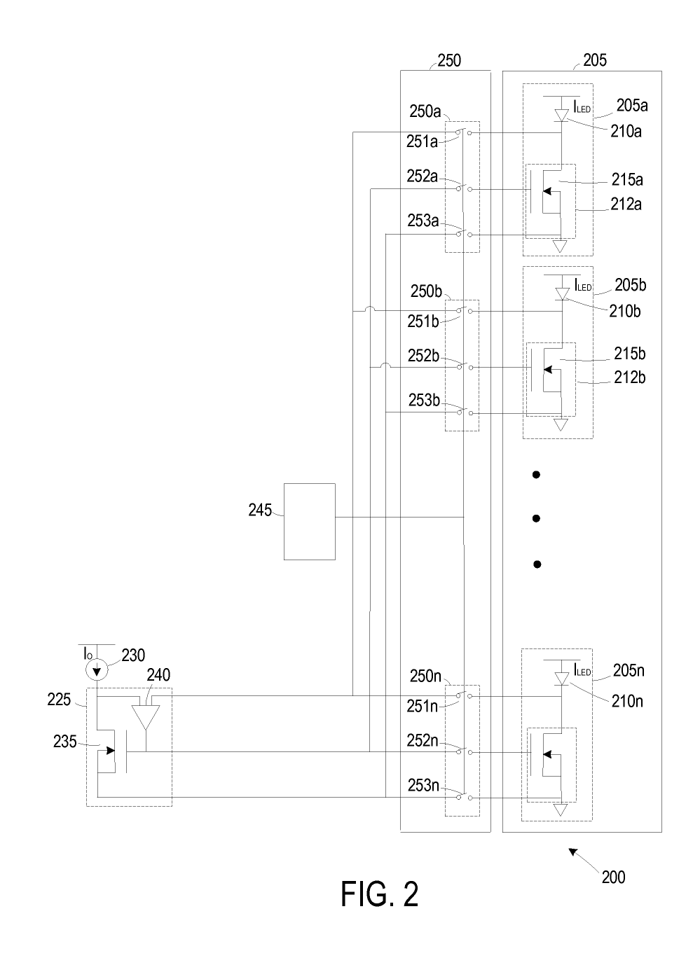

FIG. 2 is a simplified schematic of a light source 200 according to one embodiment of the present invention. Light source 200 includes a set 205 of channels. Each channel is labeled with the base reference number 205 and an alphabetic suffix. Each channel includes an LED (the LEDs are labeled 210a, 210b . . . 210n in FIG. 2) and a first current-regulator portion (the first current-regulator portions are labeled 212a, 212b . . . 212n in FIG. 2). In this example, each of the first current-regulator portions includes a first pull-down transistor (the first pull-down transistors are labeled 215a, 215b . . . 215n in FIG. 2). Each first pull-down transistor may be an NMOS transistor with a drain coupled to an output node of an LED and a source coupled to ground. Drains and sources are sometimes referred to herein as terminals. The input node of each LED may be coupled to a supply voltage, such as Vdd.

According to one embodiment, light source 200 includes a second current-regulator portion 225 and a current source 230. In this example, second current-regulator portion 225 includes a second pull-down transistor 235 and an op-amp 240. Current source 230 may be tied to the supply voltage and may be coupled to a drain of second pull-down transistor 235. Current source 230 may also be coupled to a first input of op-amp 240 where an output of the op-amp is coupled to the gate of second pull-down transistor 235.

Light source 200 may also include a set 250 of switches where the set of switches 250 includes subsets of switches labeled 250a, 250b . . . 250n. Each subset of switches may include a first switch (the first switches are labeled 251a, 251b . . . 251n in FIG. 2), a second switch (the second switches are labeled 252a, 252b . . . 252n in FIG. 2), and a third switch (each third switch is labeled 253a, 253b . . . 253n in FIG. 2). Each first switch is coupled to a second input of op-amp 240 and is configured to selectively couple the second input of the op-amp to an output node of one of the LEDs and to the drain of one of the first pull-down transistors. Each second switch is coupled to an output of op-amp 240 and a gate of second pull-down transistor 235 and is configured to selectively couple the output of op-amp 240 and the gate of second pull-down transistor 235 to a gate of one of the first pull-down transistors. Each third switch is coupled to a source of second pull-down transistor 235 and is configured to selectively couple the source of the second pull-down transistor to a source of one of the first pull-down transistors.

Light source 200 may include a digital control circuit 245, which is configured to control the selective opening and closing of the first, second, and third switches in each subset of switches. The first, second, and third switches in each subset of switches may be transistors, sets of transistors, or the like as will be readily understood by those of skill in the art.

More specifically, each subset of switches is configured to selectively couple the second current-regulator portion 225 to one of the first current-regulator portions so that a current regulator is formed for one of the LEDs. The foregoing described selective coupling of the specific portions (by the first, second, and third switches in each subset of switches) of the first and second current-regulator portions causes the current regulators to be formed. According to one embodiment, the subsets of switches may be configured to sequentially couple and then decouple each one of the first current-regulator portions to and from the second current-regulator portion so that the second current-regulator portion sequentially forms a current regulator with each first current-regulator portion to sequentially provide controlled current pull down for each LED. According to one embodiment, the switches in a given subset of switches are closed at a given time and the switches in other subsets are open during the given time.

Each formed current regulator may be configured to minor a current Io from current source 230 through one of the LEDs. The mirrored current through each LED is labeled ILED in FIG. 2. Specifically, op-amp 240 receives a voltage from current source 230 and a voltage from an output node of one of the LEDs, for which a current regulator is formed, and controls the gates of the first and second pull-down transistors for mirroring current. More specifically, op-amp 240 causes the gate-source voltages and the drain-source voltages of one of the first pull-down transistors, for which a current regulator is formed, and the second pull-down transistor to match so that the current ILED is matched to current Io.

According to one embodiment, if light source 200 is generating light (i.e., “on”), the subsets of switches are sequentially opened and closed at a given frequency such that each of the first pull-down transistors remains continuously on so that the luminosity generated by each LED is substantially constant. The luminosity generated by each LED is substantially constant because the gate area and the gate capacitance of each first pull-down transistor is relatively large such that during the period that a subset of switches (e.g., first, second, and third switches 251a, 252a, and 253a) for a given LED (e.g., LED 210a) are open, the gate capacitance of the gate holds sufficient charge on the gate so that the first pull-down transistor (e.g., first pull-down transistors 215a) remains on, and the given LED generates substantially constant luminosity. That is, the period of time is relatively short in which a current regulator is not formed by an LED's first pull-down transistor and the second pull-down transistor such that leakage current from the gate capacitance of the LED's first pull-up transistor is substantially low so that the first pull-down transistor stays on causing the LED generate substantially constant luminosity.

Second pull-down transistor 235 has a given size, which is referred to as a unit size, or simply as a unit. According to one embodiment, each first pull-down transistor has a size that is a multiple of the unit size of the second pull-down transistor. The multiple may be relatively large, such as fifty, one hundred, etc.

By sharing of a single second pull-down transistor in each current regulator formed in light source 200, the current and voltage mismatch between current regulators is substantially reduced compared to tradition light sources having multiple LEDs because the variation between multiple second pull-down transistors in multiple current regulators is eliminated. Thereby, the difference in the luminosity generated by the LEDs of light source 200 is relatively low.

According to a further embodiment, the gate size of each first pull-down transistors is substantially larger than the gate size of the second pull-down transistor. For example, the gate size of each first pull-down transistor may be ten times to one hundred times (or more) larger than the gate size of the second pull-down transistor. Because the gate sizes of the first pull-down transistors may be relatively large, the mismatch in the gate sizes of the first pull-down transistors compared to the gate sizes of the gates of the first pull-down transistors may be relatively small (e.g., less than one percent). Further, because the gate sizes of the first pull-down transistors may be relatively large and the mismatch in the gate sizes may be relatively small, the voltage and current mismatch between the first pull-down transistors may be relatively small such that a difference in the luminosity of the LEDs due to the voltage and current mismatch from the first pull-down transistors may be unnoticeable by human users.

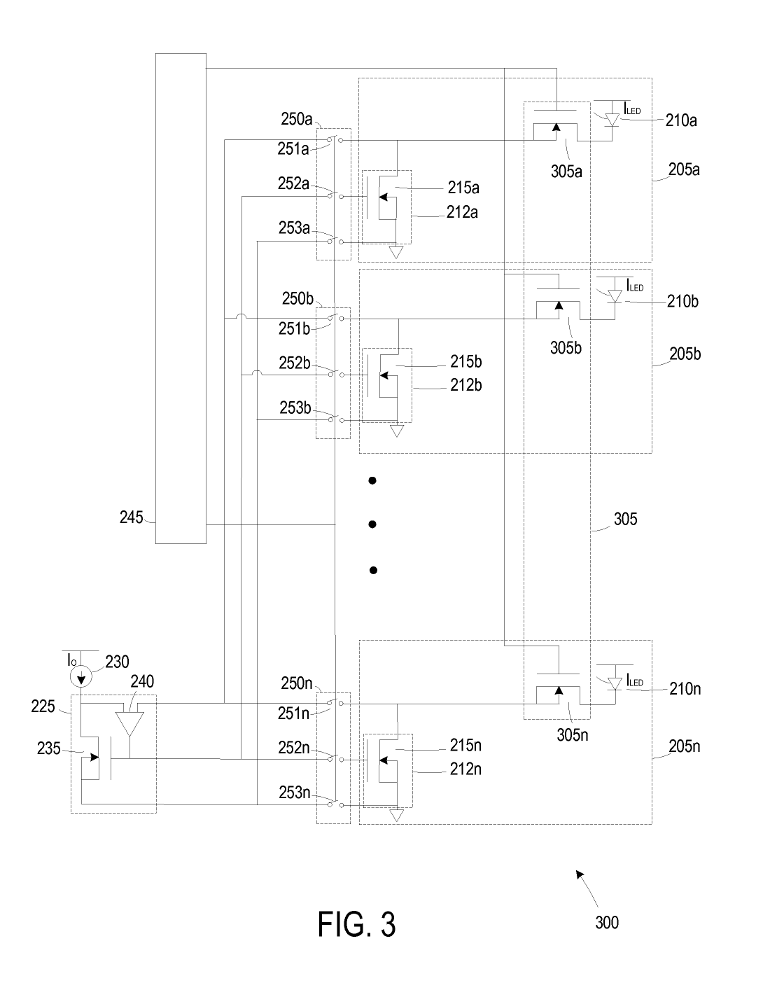

FIG. 3 is a simplified schematic of a light source 300 according to another embodiment of the present invention. The same number scheme used above for light source 200 is used for light source 300 to identify the same or substantially similar elements. Light source 300 is substantially similar to light source 200 but differs in that light source 300 includes a set of transistors 305 (the transistors in set 305 are labeled 305a, 305b . . . 305n in FIG. 3) where each transistor in the set of transistors is included in one of the channels. Specifically, transistor 305a is included in channel 205a and is disposed in series with first pull-down transistor 215a where transistors 305a and first pull-down transistor 215a are disposed between LED 210a and ground. Transistor 305b is included in channel 205b and is disposed in series with first pull-down transistor 215b where transistor 305b and first pull-down transistor 215b are disposed between LED 210b and ground, etc. More specifically, transistors 305a includes a source coupled to the drain of first pull-down transistor 215a and includes a drain coupled to the output node of LED 210a. Transistors 305b includes a source coupled to the drain of first pull-down transistor 215b and includes a drain coupled to the output node of LED 210b. Other transistors (e.g., 305n) in set 305 are similarly configured to transistors 305a and 305b. The gate of each of transistors 305a, 305b . . . 305n is coupled to digital control block 245, which is configured to turn the transistors on and off. According to one embodiment, transistors 305a, 305b . . . 305n are NMOS transistors.

According to one embodiment, the gate size of each transistor 305a, 305b . . . 305n is smaller (e.g., 10 times smaller or less) than the gate sizes of first pull-down transistors 215a, 215b . . . 215n. Due to the relatively small gate sizes of transistors 305a, 305b . . . 305n, these transistors may be configured to turn on and turn off relatively quickly. According to one embodiment, digital control block 245 is configured to apply a control voltage to the gates of transistors 305a, 305b . . . 305n to turn transistors 305a, 305b . . . 305n on and off at a given frequency and according to a given duty cycle of the given frequency. By turning transistors 305a, 305b . . . 305n on and off according to a given frequency and given duty cycle, the current ILED pull down through each LED may be controlled. That is, the current ILED pull down through each LED may be increased or decreased dependent on the given frequency and the given duty cycle of the control voltage applied to the gates of transistors 305a, 305b . . . 305n. A relative decrease in the current ILED pulled down through the LEDs causes the LEDs to decrease the luminosity generated by the LEDs (i.e., the light source dims), and a relative increase in the current ILED pulled down through the LEDs causes the LEDs to increase the luminosity generated by the LEDs (i.e., the light source brightens).

While light sources 200 and 300 are described as including current regulators configured to pull current down through LEDs 210a, 210b . . . 210n via the output nodes of the LEDs, alternative light source embodiments may include current regulators, which are configured to source current to the input nodes the LEDs where the output nodes of the LEDs are coupled to ground.

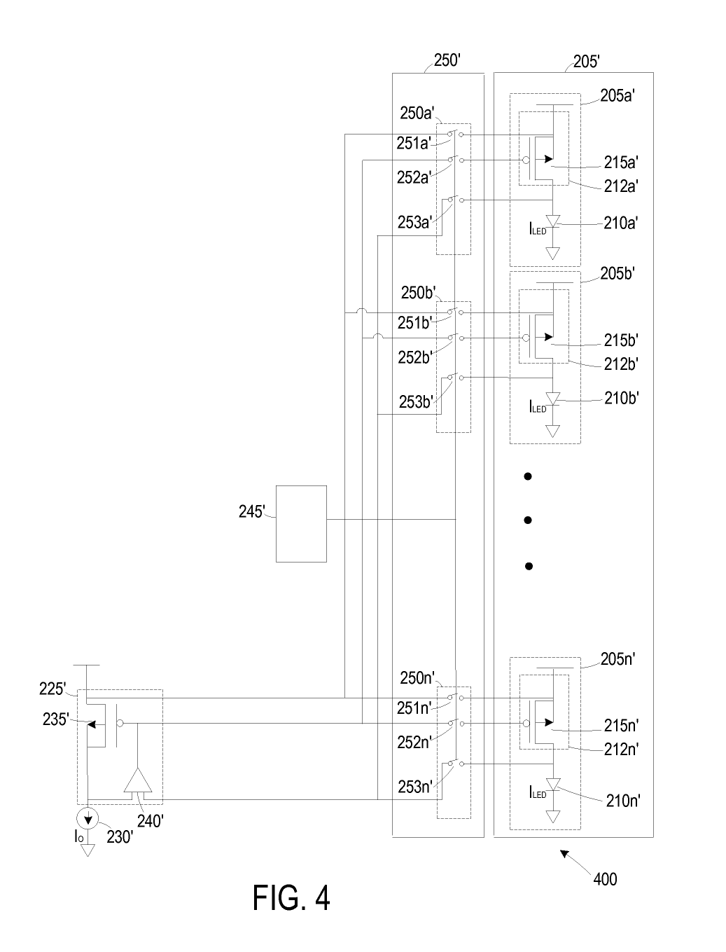

FIG. 4 is a simplified schematic of a light source 400 according to another embodiment of the present invention. The same numbering scheme used above for light source 200 is used for light source 400 with primes added to the numbers so that similar elements in light sources 200 and 400 may be readily identified. Light source 400 is substantially similar to light source 200 described above expect that the current regulators of light source 400 are configured to source current ILED to the input nodes of the LEDs rather than pull current ILED down through the output nodes of the LEDs. The formed current regulators of light source 400 are described in further detail below.

Light source 400 includes a set 205′ of channels where the channels are labeled 205a′, 205b′ . . . 205n′ in FIG. 4. Each channel includes an LED (the LEDs are labeled 210a′, 210b′ . . . 210n′ in FIG. 4) and a first current-regulator portion (the first current-regulator portions are labeled 212a′, 212b′ . . . 212n′ in FIG. 4). In this example, each of the first current-regulator portions includes a first pull-up transistor (the first pull-up transistors are labeled 215a′, 215b′ . . . 215n′ in FIG. 2). Each first pull-up transistor may be a PMOS transistor with a drain coupled to an input node of an LED and a source coupled to the supply voltage.

According to one embodiment, light source 400 further includes a second current-regulator portion 225′ and a current source 230′. Second current-regulator portion 225′ includes a second pull-up transistor 235′ and an op-amp 240′. Second pull-up transistor 235′ may be a PMOS transistor. Current source 230′ may be coupled to a drain of second pull-up transistor 235′ and may be configured to pull current from the drain. Current source 230′ may also be coupled to a first input of op-amp 240′ where an output of the op-amp is coupled to the gate of second pull-up transistor 235′.

Similar to light source 200, light source 400 may also include a set of switches 250′ where the set of switches 250′ includes subsets of switches. The subsets of switches are labeled 250a′, 250b′ . . . 250n′. Each subset of switches may include a first switch (the first switches are labeled 251a′, 251b′ . . . 251n′ in FIG. 4), a second switch (the second switches are labeled 252a′, 252b′ . . . 252n′ in FIG. 4), and a third switch (each third switch is labeled 253a′, 253b′ . . . 253n′ in FIG. 4). Each of the first switches 251a′, 251b′ . . . 251n′ is coupled to a source of the second pull-up transistor 235′ and is configured to selectively couple the source of the second pull-up transistor to a source of one of the first pull-up transistors. Each of the second switches 252a′, 252b′ . . . 252n′ is coupled to an output of op-amp 240′ and a gate of second pull-up transistor 235′ and is configured to selectively couple the output of op-amp 240′ and the gate of second pull-up transistor 235′ to a gate of one of the first pull-up transistors. Each of the third switches 253a′, 253b′ . . . 253n′ is coupled to a second input of op-amp 240′ and is configured to selectively couple the second input of the op-amp to an input node of one of the LEDs and to the drain of one of the first pull-up transistors.

Light source 400 may include a digital control circuit 245′, which is configured to control the selective opening and closing of the first, second, and third switches in each subset of switches. The first, second, and third switches in each subset of switches may be transistors, sets of transistors, or the like as will be readily understood by those of skill in the art.

More specifically, each subset of switches is configured to selectively couple the second current-regulator portion 225′ to one of the first current-regulator portions so that a current regulator is formed for one of the LEDs. The foregoing described selective coupling of the specific portions (by the first, second, and third switches in each subset of switches) of the first and second current-regulator portions causes the current regulators to be formed. According to one embodiment, the subsets of switches may be configured to sequentially couple and then decouple each one of the first current-regulator portions to and from the second current-regulator portion so that the second current-regulator portion sequentially forms a current regulator with each first current-regulator portion to sequentially provide controlled sourced current to each LED. According to one embodiment, the switches in a given subset of switches are closed at a given time and the switches in other subsets are open during the given time.

Each formed current regulator may be configured to mirror a current Io from current source 230′ through one of the LEDs. Specifically, op-amp 240′ receives the voltages from current source 230′ and an input node of one of the LEDs, for which a current regulator is formed, and controls the gates of the first and second pull-up transistors for mirroring current. More specifically, op-amp 240′ causes the gate-source voltages and the drain-source voltages of one of the first pull-up transistors, for which a current regulator is formed, and the second pull-up transistor to match so that the current ILEA is matched to the current Io.

According to one embodiment, if light source 400 is generating light (i.e., “on”), the subsets of switches are sequentially opened and closed at a given frequency such that each of the first pull-up transistors remains continuously on so that the luminosity generated by each LED is substantially constant. That is, each LED remain on during the time that the subset of switches for the LED are open and a current regulator is not formed for the LED. More specifically, the luminosity generated by each LED is substantially constant because the gate area and the gate capacitance of each first pull-up transistor is relatively large such that during the period that a set of switches (e.g., first, second, and third switches 251a′, 252a′, and 253a′) for a given LED (e.g., LED 210a′) are open, the gate capacitance of the gate holds sufficient charge on the gate so that the first pull-up transistor (e.g., first pull-up transistor 215a′) remains on, and the given LED generates substantially constant luminosity. That is, the period of time is relatively short in which a current regulator is not formed by a given LED's first pull-up transistor and the second pull-up transistor such that leakage current from the gate capacitance of the LED's first pull-up transistor is substantially low so that the first pull-up transistor stays on causing the LED to generating substantially constant luminosity.

Second pull-up transistor 235′ has a given size, which is referred to as a unit size, or simply as a unit. According to one embodiment, each first pull-up transistor has a size that is a multiple of the unit size of the second pull-up transistor. The multiple may be relatively large, such as fifty, one hundred, etc.

By sharing of a single second pull-up transistor in each current regulator formed in light source 400, the current and voltage mismatch between current regulators is substantially reduced compared to tradition light sources having multiple LEDs. Thereby, the difference in the luminosity generated by the LEDs of light source 400 is relatively low.

According to a further embodiment, the gate size of each first pull-up transistors is substantially larger than the gate size of the second pull-up transistor. For example, the gate size of each first pull-up transistor may be ten times to one hundred times (or more) larger than the gate size of the second pull-up transistor. Because the gate sizes of the first pull-up transistors may be relatively large, the mismatch in the gate sizes of the first pull-up transistors compared to the gate sizes of the gates of the first pull-up transistors may be relatively small (e.g., less than one percent). Further, because the gate sizes of the first pull-up transistors may be relatively large and the mismatch in the gate sizes may be relatively small, the voltage and current mismatch between the first pull-up transistors may be relatively small such that differences in the luminosity of the LEDs due to the voltage and current mismatch may be unnoticeable by human users.

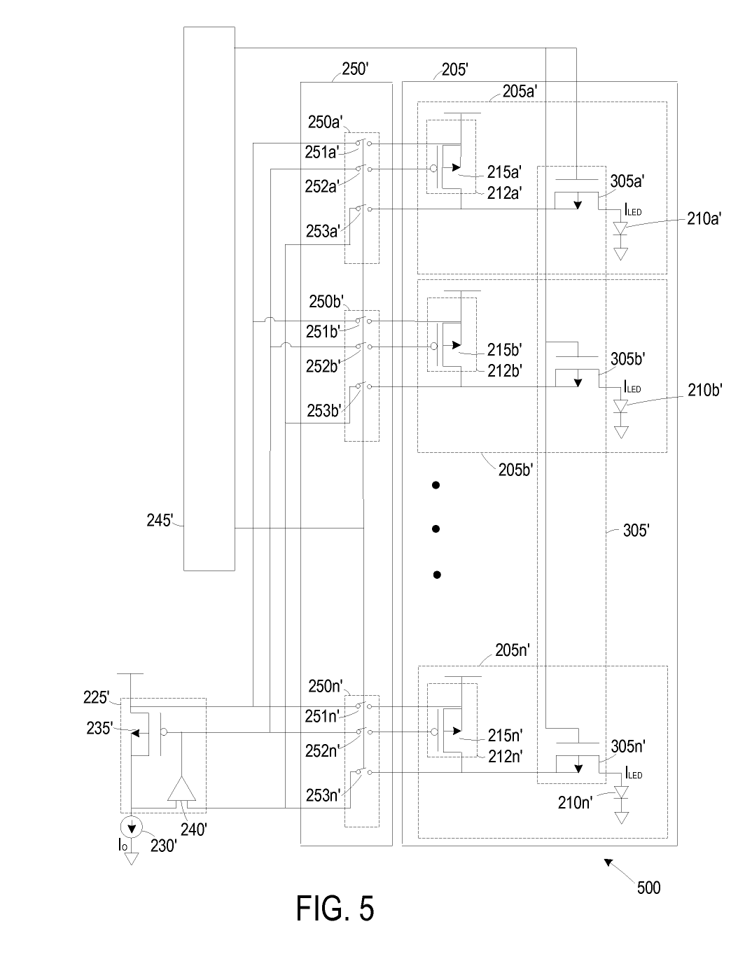

FIG. 5 is a simplified schematic of a light source 500 according to another embodiment of the present invention. The same number scheme used above for light source 400 is used for light source 500 to identify the same or substantially similar elements. Light source 500 is substantially similar to light source 400 but differs in that light source 500 includes a set of transistors 305′ (the transistors in set 305′ are labeled 305a′, 305b′ . . . 305n′ in FIG. 5) where each transistor in the set of transistors is included in one of the channels. Specifically, transistor 305a′ is included in channel 205a′ and is disposed in series with first pull-up transistor 215a′ where transistor 305′ and first pull-up transistor 215′ are disposed between LED 210a′ and the supply voltage. Transistor 305b′ is included in channel 205b′ and is disposed in series with first pull-up transistor 215b′ where transistor 305b′ and first pull-up transistor 215b′ are disposed between LED 210b′ and the supply voltage, etc. More specifically, transistors 305a′ includes a source coupled to the drain of first pull-up transistor 215a′ and includes a drain coupled to the input node of LED 210a′. Transistors 305b′ includes a source coupled to the drain of first pull-up transistor 215b′ and includes a drain coupled to the input node of LED 210b′. Other transistors (e.g., 305n′) in set 305′ are similarly configured to transistors 305a′ and 305b′. The gate of each of transistors 305a′, 305b′ . . . 305n′ is coupled to digital control block 245′, which is configured to turn the transistors on and off. According to one embodiment, transistors 305a′, 305b′ . . . 305n′ are PMOS transistors.

According to one embodiment, the gate size of each transistor 305a′, 305b′ . . . 305n′ are smaller (e.g., 10 times smaller or more) than the gate size of first pull-up transistors 215a′, 215b′ . . . 215n′. Due to the relatively small gate sizes of transistors 305a′, 305b′ . . . 305n′, these transistors may be configured to turn on and turn off relatively quickly. According to one embodiment, digital control block 245′ is configured to apply a control voltage to the gates of transistors 305a′, 305b′ . . . 305n′ to turn transistors 305a′, 305b′ . . . 305n′ on and off at a given frequency and according to a given duty cycle of the given frequency. By turning transistors 305a′, 305b′ . . . 305n′ on and off according to a given frequency and given duty cycle, the current ILED sourced to each LED may be controlled. That is, the current ILED sourced to each LED may be increased or decreased dependent on the given frequency and the given duty cycle to increase or decrease the current ILED to thereby increase or decrease the luminosity generated by the LEDs.

According to one embodiment, the circuit elements of light sources 200, 300, 400, and 500 may be included in an integrated circuit. The integrated circuit might not include the LEDs.

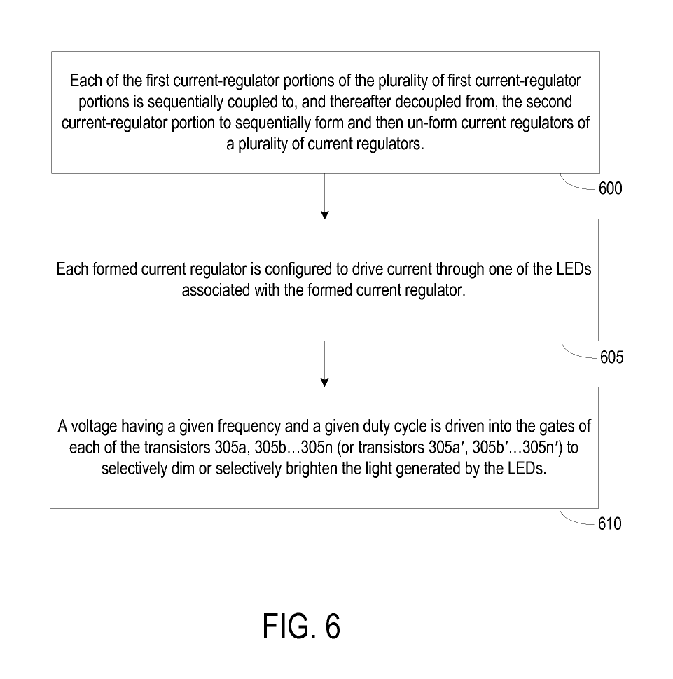

FIG. 6 is a high-level flow diagram of a circuit operation method according to one embodiment of the present invention. The high-level flow diagram is exemplary and those of skill in the art will recognize that various steps of the high-level flow diagram may be added, and/or combined without deviating from the scope and purview of the described embodiment.

Those of skill in the art will further recognize that various subsets of the of steps of the high-level flow diagram are also embodiments of the present invention and that the steps in FIG. 6 are shown to import a high-level understanding of embodiments described herein. At a step 600, each of the first current-regulator portions of the plurality of first current-regulator portions is sequentially coupled to, and thereafter decoupled from, the second current-regulator portion to sequentially form and then un-form each of the current regulators. The current regulators may be formed one at a time during a unique temporal window. That is, one current regulator is formed during a period in which no other current regulators are formed. At a step 605, each formed current regulator is configured to drive current through one of the LEDs associated with the formed current regulator. At a step 610, a voltage having a given frequency and a given duty cycle is driven into the gates of each of the transistors 305a, 305b . . . 305n (or transistors 305a′, 305b′ . . . 305n′) to selectively dim or selectively brighten the light generated by the LEDs. Various alternative embodiments do not include step 610, for example, for light sources that do not provide for dimming.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A circuit comprising:
a plurality of first current-regulator portions;
a second current-regulator portion; and
a plurality of switches coupled to the second current-regulator portion, wherein the plurality of switches is configured to sequentially and selectively couple the first current-regulator portions to the second current-regulator portion to sequentially form current regulators, and wherein the current regulators are configured to regulate current flow through light emitting diodes (LEDs), which are respectively associated with the first current-regulator portions.

2. The circuit of claim 1, further comprising a digital control block coupled to the plurality of switches, wherein the digital control block is configured to control the plurality of switches to sequentially and selectively couple the first current-regulator portions to the second current-regulator portion.

3. The circuit of claim 2, wherein each of the first current-regulator portions includes a first pull-down transistor having a first terminal coupled to ground and a second terminal is coupled to one of the LEDs to pull current through the LED.

4. The circuit of claim 3, further comprising a current source coupled to a supply voltage, wherein the second current-regulator portion includes:
a second pull-down transistor having a first terminal coupled to the current source and a second terminal one of the switches, and
an op-amp having a first input coupled to the first terminal, a second input coupled to one of the switches, and an output coupled to a gate of the second pull-down transistor.

5. The circuit of claim 4, wherein a gate of each of the first pull-down transistors is larger than the gate of the second pull-down transistor.

6. The circuit of claim 3, wherein each of the first pull-down transistors is configured to remain on during periods that the switches are open and closed.

7. The circuit of claim 3, wherein each of the first current-regulator portions includes a second transistor disposed in series with the first pull-down transistor between an output node of one of the LEDs and ground.

8. The circuit of claim 7, wherein the digital control block is coupled to a gate of each of the second transistors to turn the second transistors on and off to dim the LEDs.

9. The circuit of claim 2, wherein each of the first current-regulator portions includes a first pull-up transistor having a first terminal coupled to a supply voltage and a second terminal is coupled to one of the LEDs to source current to the LED.

10. The circuit of claim 9, further comprising a current source coupled to a supply voltage, wherein the second current-regulator portion includes:
a second pull-up transistor having a first terminal coupled to the current source and a second terminal one of the switches, and
an op-amp having a first input coupled to the first terminal, a second input coupled to one of the switches, and an output coupled to a gate of the second pull-up transistor.

11. The circuit of claim 10, wherein a gate of each the first pull-up transistors is larger than a gate of the second pull-down transistor.

12. The circuit of claim 11, wherein each of the first pull-up transistors is configured to remain on during periods that the switches are open and closed.

13. The circuit of claim 9, wherein each of the first current-regulator portions includes a transistor disposed in series with the first pull-down transistor between an output node of one of the LEDs and ground.

14. The circuit of claim 13, wherein the digital control block is coupled to a gate of each of the transistors to turn the transistors on and off to dim the LEDs.

15. A circuit method for operating a light emitting diode (LED) light source comprising:
sequentially coupling and decoupling each first current-regulator portion of a plurality of first current-regulator portions to a second current-regulator portion to sequentially form and un-form current regulators; and
driving current through each LED of a plurality of LEDs via each of the formed current regulators.

16. The circuit method of claim 15, wherein the step of sequentially coupling and decoupling each first current-regulator portion includes sequentially opening and closing sets of switches to sequentially couple and decouple each of the first current-regulator portions to the second current-regulator portion.

17. The circuit method of claim 15, wherein the driving step includes mirroring a current from a current source through each of the LEDs via the formed current regulators.

18. The circuit method of claim 15, wherein the driving step includes pulling current down through output nodes of the LEDs via the formed current regulators.

19. The circuit method of claim 18, wherein the driving step includes pulling current down through each of the output nodes of each of the LEDs via the LED's first current regulator portions during a period that a current regulator is not formed for the LED.

20. The circuit method of claim 15, wherein the driving step includes sourcing current to input nodes of the LEDs via the formed current regulators.

21. The circuit method of claim 20, wherein the driving step includes sourcing to the input nodes of each of the LEDs via the LED's first current regulator portions during a period that a current regulator is not formed for the LED.
